(19) United States
(12) Patent Application Publication
(10) Pub. No.: US 2021/0040693 A1
(43) Pub. Date: Feb. 11, 2021

(54) METHODS OF FORMING A CONTINUOUS LAYER OF AN AQUEOUS COATING ON THE SURFACE OF A PAPER-BASED PRODUCT AND OIL-RESISTANT FOOD PACKAGING

(71) Applicants: The United States of America, as represented by the Secretary of Agriculture, Washington, DC (US); World Centric, Petaluma, CA (US)

(72) Inventors: Gregory M. Glenn, American Canyon, CA (US); Artur P. Klamczynski, Orinda, CA (US); Xing Jin, ALBANY, CA (US)

(21) Appl. No.: 16/987,751

(22) Filed: Aug. 7, 2020

Related U.S. Application Data
(60) Provisional application No. 62/884,228, filed on Aug. 8, 2019.

(51) Int. Cl. D21H 19/12; C09D 129/04; D21H 19/20

(52) U.S. Cl. CPC D21H 19/12; D21H 21/16; D21H 19/20; C09D 129/04

(57) ABSTRACT

Disclosed are methods that facilitate formation of a continuous layer of aqueous coating on the surface of paper-based products via appropriate hydrophobicity on the to-be-coated surface. The methods are applied to provide useful characteristics or functions to paper products, for example, good oil resistance. The methods do not involve the use of polyfluoroalkyl substances (PFAS). Also disclosed are articles of manufacture produced using these methods

### REFERENCE TO RELATED APPLICATION

This application claims the benefit of U.S. Provisional Application No. 62/884,228, filed 8 Aug. 2019, which is incorporated herein by reference in its entirety.

### FIELD OF THE INVENTION

The present invention relates generally to methods that effectively facilitate forming a continuous layer of a functional (e.g., protective) aqueous coating on the surface of paper-based products; the aqueous coating provides, for example, oil resistance to the surface. The facilitating mechanism is associated with appropriate hydrophobicity at the surface to be coated. More particularly, the invention relates to improved food-safe coatings that are free of polyfluoroalkyl substances, are biodegradable, and provide, for example, excellent oil-resistance to paper-based products.

### BACKGROUND OF THE INVENTION

Containers and other packaging materials are generally designed to protect items from external damage (e.g., moisture, impacts, crushes, vibration, leakage, spills, gases, light, extreme temperatures, contamination, animal and insect intrusion, etc.) and may also contain information about the items therein. For example, containers and packages designed for use in the food and beverage industries are widely used throughout the world. The concept of single-use food and beverage containers as an inexpensive, sanitary, and convenient alternative to reusable types has increased nearly fivefold since 1960. The value of single-use food and beverage containers in safeguarding human health and improving hygiene is often lost in the discussion of its role as a convenience and as a significant source of pollution and municipal solid waste. Plastics (e.g., polystyrene, polyethylene terephthalate, polypropylene, high-density polyethylene, low-density polyethylene, polycarbonate, etc.) are commonly used and offer the benefits of ease of manufacturing, light weight, low cost, and inherent moisture and oil resistance. Polystyrene is a commonly used plastic in making disposable plates and cups. In 2012, it is estimated that 0.83 MMT of polystyrene plates and cups were used and discarded as municipal waste (see e.g., EPA, U., Municipal Solid Waste Generation, Recycling, and Disposal in the United States: Facts and Figures for 2012).

Paper-based food containers are generally biodegradable and have a low cost, thus they are desirable for single-use application. They comprise a huge market, including products such as paper plates, bowls, take-out boxes, pizza boxes, etc. One disadvantage of using paper products, however, is that the paper tends to absorb oils from food which impacts the quality of the food, the integrity of the paper product, and customer experience. The benefits of disposable paper food containers as compostable and low cost are often overshadowed by issues arising from the additives used to provide oil resistance to the containers. Currently additives and coatings of polyfluoroalkyl substances (PFAS) are the main commercially feasible way to provide adequate oil resistance for paper-based food containers. While some varieties of PFAS are no longer used due to regulatory changes, most of the PFAS still on the market are, for example, acrylate copolymers containing side groups of perfluoroalkyl ester which still have toxicity and environmental risks. In addition, PFAS chemicals are relatively expensive, and therefore replacements are needed.

Even without the requirement of biodegradability or compostability, there is very limited commercially existing non-PFAS coatings, let alone additives, able to provide desirable oil resistance for paper-based food containers as effectively as PFAS. Without using PFAS, the most common approach is surface lamination of paper-based products using a thin plastic film. Such a non-biodegradable plastic lamination generally disqualifies products from composting after use, whereas biodegradable plastic lamination generally increases material costs too much. Water based aqueous coatings do not contain toxic volatile organic solvents and thus are environment friendly. Many aqueous emulsions of synthetic polymers such as styrene-butadiene copolymers, acrylates, ethylene-acrylate copolymers, vinyl esters, etc., and many aqueous dispersion of biodegradable polyesters especially polylactic acid and polyhydroxyalkanoates, have been developed as paper coatings to improve water/moisture or oil/grease resistance, whilst effectiveness of which is significantly lower than that with PFAS both theoretically and practically. Synthetic polymer, polyvinyl alcohol (PVOH), is non-toxic, biodegradable under certain conditions, FDA-approved for food contact, and does not generally affect paper re-pulping. To improve water or oil resistance, there have been reports on using aqueous solutions of biodegradable natural products which mainly include proteins such as corn protein, soy protein, gluten, casein, etc., and polysaccharides such as cellulose, hemicellulose, chitosan, alginate and starch, etc. Abundant hydrophilic hydroxyl groups of PVOH and polysaccharides theoretically ensure high oxygen gas barrier and high resistance to oil and grease; however, in practice, so far it has proven difficult to achieve related high performances. Effectiveness of any coating depends heavily on whether the coating is continuous and pinhole free. As we demonstrate below using PVOH solution, aqueous coatings easily penetrate fast into conventional paper substrates, which makes it difficult to form a continuous layer of coating for desired barrier functions.

There thus exists an ongoing need for novel and improved food safe coatings that are economical and industrially efficient to apply. There is a particular need for food safe oil-resistant coatings that are free of PFAS, are biodegradable, and preferably use renewable resources.

### SUMMARY OF THE INVENTION

To address these challenging issues, the present invention provides novel methods to allow aqueous coatings distributed continuously and uniformly on paper-based products. The method is used to obtain or produce food safe coatings on paper-based products without the use of PFAS. In an aspect, this invention is a method of obtaining a coating that provides, for example, excellent oil resistance on various types of paper-based products. The applied composition in the method includes a formulation of poly(vinyl alcohol) that optionally is crosslinked, while the method also works for applying other aqueous coatings which also provide, for example, oil resistance to the surface of a paper-based product. This invention relates to methods of applying the formulation to paper-based products. The methods may be used for a variety of paper-based products such as paper sheets, boards, molded products, etc. with continuous surfaces for the formulation to be applied. The paper-based products must have a hydrophobic surface.

It is an advantage of the invention to provide novel methods of obtaining high oil resistance with PFAS-free coatings for paper-based products.

It is another advantage of the present invention to provide methods for imparting oil resistance to paper products using cost effective materials.

An additional advantage of the invention is to provide methods that facilitate forming an essentially continuous aqueous coating layer on a paper surface from an aqueous system which may be emulsion, etc., as well as solution.

A further advantage of the present invention is to provide novel and simple methods of obtaining an oil-resistant coating on pre-shaped paper products and molded-pulp products.

This summary is provided to introduce a selection of concepts in a simplified form that are further described below in the detailed description. This summary is not intended to identify all key or essential features of the claimed subject matter, nor is it intended to limit the scope of the claimed subject matter.

### BRIEF DESCRIPTION OF THE DRAWINGS

FIGS. 1A, FIG. 1B, FIG. 1C, and FIG. 1D show scanning electron micrographs of the surface of paper samples coated using the inventive method and loaded with varying amounts of water-resistant additive as described below to show the effectiveness of the present invention and to help analyze the mechanism.

### DETAILED DESCRIPTION OF THE INVENTION

Unless herein defined otherwise, all technical and scientific terms used herein generally have the same meaning as commonly understood by one of ordinary skill in the art to which this invention belongs. The definitions and terminology herein described for embodiments may or may not be used in capitalized as well as singular or plural form herein and are intended to be used as a guide for one of ordinary skill in the art to make and use the invention and are not intended to limit the scope of the claimed invention. Mention of trade names or commercial products herein is solely for the purpose of providing specific information or examples and does not imply recommendation or endorsement of such products.

As used in the description of the invention and the appended claims, the singular forms “a,” “an,” and “the” are intended to include the plural forms as well, unless the context clearly indicates otherwise.

The term “consisting essentially of” excludes additional method steps or composition components that substantially interfere with the intended activity of the methods or compositions of the invention and can be readily determined by those skilled in the art (e.g., from a consideration of this specification or practice of the invention disclosed herein). This term may be substituted for inclusive terms such as “comprising” or “including” to more narrowly define any of the disclosed embodiments or combinations/sub-combinations thereof. Furthermore, the exclusive term “consisting” is also understood to be substitutable for these inclusive terms in alternative forms of the disclosed embodiments.

The term “effective amount” of a compound or property as provided herein is meant such amount as is capable of performing the function of the compound or property for which an effective amount is expressed. As is pointed out herein, the exact amount required will vary from process to process, depending on recognized variables such as the compounds employed and various internal and external conditions observed as would be interpreted by one of ordinary skill in the art. Thus, it is not possible to specify an exact “effective amount,” though preferred ranges have been provided herein. An appropriate effective amount may be determined, however, by one of ordinary skill in the art using only routine experimentation.

The term “optional” or “optionally” means that the subsequently described event or circumstance may or may not occur, and that the description includes instances and embodiments in which said event or circumstance occurs and instances and embodiments where it does not. For example, the phrase “optionally comprising a crosslinker” means that the composition may or may not include a crosslinker and that this description includes compositions of both varieties. Also, by example, the phrase “optionally adding a crosslinker” means that the method may or may not involve adding a crosslinker and that this description includes methods that involve and do not involve adding a crosslinker.

The term “paper-based product” refers to any article of manufacture, receptacle, or vessel used for storing, dispensing, transferring, packaging, portioning, or shipping various types of products, objects, or items (e.g., food and beverage products). Specific examples of such products include boxes, cups, jars, bottles, plates, dishes, bowls, trays, cartons, cases, crates, cereal boxes, frozen food boxes, milk cartons, carriers and holders (e.g., egg cartons, 6-pack holders, boxes, bags, sacks), lids, straws, envelopes, and the like. The products may include any traditional ingredients for paper items such as plant-derived complex carbohydrates generally forming threads or filaments, often categorized as either water soluble or water insoluble. Fibers may vary in their shape such as filamentous, cylindrical, oval, round, elongated, globular, the like, and combinations thereof. Their size may range from nanometers up to millimeters. Natural fibers are generally derived from substances such as cellulose, hemicellulose, lignin, pectin, and proteins. Tree fibers, for example, are often chemically pulped to remove many non-cellulosic fiber components and form a cellulose-rich fiber composition that is used to make commercial paper and paperboard. Fibers from soft and hardwood trees are commonly used to make most of the paper and paperboard products sold in markets today. Some agricultural crops are grown specifically for their high-strength fibers such as flax, sisal, hemp, linen, cotton, coir, and jute. However, fibers from agricultural residues such as straw, onion, and artichoke are traditionally discarded or left in the field and may provide a more sustainable source of fiber for use in manufacturing products containing a fiber component. The paper-based product must have a hydrophobic surface.

As noted above, this invention relates to methods of applying the formulation to paper-based products. The term “applying an aqueous coating” includes applying an aqueous coating, dispersion, emulsion, solution, etc. The term “applying” may be, for example, by spraying the aqueous coating (e.g., solution of poly(vinyl alcohol)) to the surface of the paper-based product, rolling the aqueous coating (e.g., solution of poly(vinyl alcohol)) to the surface of the paper-based product, brushing the aqueous coating (e.g., solution of poly(vinyl alcohol)) to the surface of the paper-based product, or using a blade to apply the aqueous coating (e.g., solution of poly(vinyl alcohol)) to the surface of the paper-based product.

While this invention may be embodied in many different forms, there are described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some or all of the various embodiments and characteristics described herein and/or incorporated herein. In addition, the invention encompasses any possible combination that also specifically excludes any one or some of the various embodiments and characteristics described herein and/or incorporated herein.

The amounts, percentages and ranges disclosed herein are not meant to be limiting, and increments between the recited amounts, percentages and ranges are specifically envisioned as part of the invention. All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10 including all integer values and decimal values; that is, all subranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions (e.g., reaction time, temperature), percentages and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. As used herein, the term “about” refers to a quantity, level, value, or amount that varies by as much as 10% to a reference quantity, level, value, or amount. For example, about 1.0 g means 0.9 g to 1.1 g and all values within that range, whether specifically stated or not.

This invention relates to methods of using a hydrophobic surface for paper-based products which enables less penetration of aqueous coatings (e.g., solutions) into the underlying paper and concomitant increased integrity and usability of the paper-based product. The approach disclosed herein provides novel methods with advantages over known alternatives and results in increased continuousness of the obtained layer of aqueous coating on the surface paper-based product. The disclosed inventive methods of applying coating compositions comprise, for example, poly(vinyl alcohol) (PVOH) optionally combined with a cross linker (or other aqueous solution which also provide, for example, oil resistance to the surface of a paper-based product). In embodiments, the disclosed methods of the invention utilize PVOH (or other aqueous solution which also provide oil resistance to the surface of a paper-based product) in an aqueous solution with low enough viscosity to be sprayed onto a paper-based product. In other embodiments, the PVOH solution (or other aqueous solution which also provide oil resistance to the surface of a paper-based product) may be applied using a roller, blade, brush, or shower coating processes that allows using a higher PVOH solution viscosity and/or higher PVOH molecular weight. Once a coating of the subject composition is applied, drying can be accelerated using known drying methods such as radiant heat, hot air, etc.

It should be appreciated that a skilled artisan would determine the best method for applying the composition for a particular application. The coating compositions are based on poly(vinyl alcohol) (PVOH) and an optional crosslinker, or other aqueous solutions which also provide oil resistance to the surface of a paper-based product. It should be appreciated that the mechanism of water and oil resistance enhancement herein described is applicable to a variety of paper products and processes including those commonly found in paper mills.

In general, with increasing molecular weight, PVOH becomes less water soluble, more water resistant, and its solution at a certain concentration becomes more viscous. PVOH is typically produced from hydrolysis of polyvinyl acetate. Not intending to be bound by theory, with increasing degree of hydrolysis (i.e., acetate groups being more completely turned into hydroxyl groups), PVOH becomes less water soluble and more water resistant due to stronger inter- and intra-molecular hydrogen bonding. In conventional commercial grades of PVOH, hydroxyl polar groups typically dominate, so these grades have good oil resistance, and oil resistance is relatively higher with a degree of higher hydrolysis. The methods of this invention provide a coating with good oil resistance via a much more convenient method as compared to known conventional and reported methods. The preferred hydrolysis extent is from about 60% to about 99% (e.g., 60-99%), or from about 70% to about 99% (e.g., 70-99%), or from about 80% to about 99% (e.g., 80-99%). Commercial grades of PVOH (or other aqueous solution which also provide oil resistance to the surface of a paper-based product) from a variety of sources as determined by a skilled artisan can generally be directly used without a need of any chemical treatment beforehand.

In embodiments, the preferred ranges of molecular weight, solution concentration, and viscosity of PVOH (or other aqueous solution which also provide, for example, oil resistance to the surface of a paper-based product) vary with different coating technologies and product applications. For methods where spray coating is used, the viscosity of the PVOH solution (or other aqueous solution which also provide, for example, oil resistance to the surface of a paper-based product) needs be low enough to allow passing of the PVOH solution (or other aqueous solution which also provide, for example, oil resistance to the surface of a paper-based product) in a desirable spraying pattern and flow from the chosen spray nozzle. Lower viscosity can generally be achieved via either lower solution concentration or lower PVOH molecular weight. Coating solution concentration needs to be as high as possible so that less amount of water is used which allows faster drying, so lower molecular weights are preferred. However, it should be appreciated that a skilled artisan would optimize the molecular weight for the application because the coating of PVOH of lower molecular weight tends to be weaker and thus more easily damaged when contacting water. For spray coating embodiments using, for example, air-brush type spray guns, preferred PVOH coating solution viscosity is from about 10 cPs to about 2000 cPs (e.g., 10-2000 cPs), or from about 50 cPs to about 1,000 cPs (e.g., 50-1,000 cPs), or from about 100 cPs to about 600 cPs (e.g., 100-600 cPs). In embodiments, the PVOH concentration is from about 2% to about 30% (e.g., 2-30%) in water (wt/vol), or from about 5% to about 20% (e.g., 5-20%), or from about 8% to about 16% (e.g., 8-16%). In embodiments, the PVOH molecular weight is from about 5,000 g/mol to about 500,000 g/mol (e.g., 5,000-500,000 g/mol), or from about 10,000 g/mol to about 200,000 g/mol (e.g., 10,000-200,000 g/mol), or from about 20,000 to about 50,000 g/mol (e.g., 20,000-50,000 g/mol).

In embodiments, the optional crosslinker component for the inventive composition is, for example, citric acid. This crosslinker is the preferred crosslinking agent because it is food compatible and maintains a low solution viscosity which allows it to be used in the methods of the invention with a high degree of effectiveness and also improves water-contact stability of the dried coating. The particular degree of crosslinking and amount used would be adjusted by a skilled artisan to arrive at the desired molecular weight and viscosity as needed for the particular application. Crosslinking may also help increase the water resistance of the inventive coating either with or without the addition of a water resistance additive. Other known food compatible crosslinkers may be used.

In embodiments, the paper product to be coated optionally contains one or more water-resistance pulp-slurry additives, such as alkyl ketene dimers, alkenyl succinic anhydrides, or rosin, etc. In embodiments, the paper product to be coated may be precoated with a hydrophobic coating and optionally dried before being coated with the inventive oil-resistance aqueous coating because some hydrophobic coatings may not need drying. The hydrophobic surface of to-be-coated paper surface provides an excellent substrate for obtaining from aqueous coating an even oil-resistant surface coating with a minimum number of pinholes through which oil can penetrate into the substrate material.

In embodiments, the coating compositions of the invention can be used as an oil-resistant coating on paper-based products in a variety of applications. A preferred application is a coating for fiber-based composite food service items and packaging. In embodiments, the invention encompasses an article of manufacture produced using the methods herein described. Such articles of manufacture may include, for example, paper-based products such as paper plates, bowls, take-out boxes, and pizza boxes.

The inventive methods herein disclosed are applications of coating formulations of optionally cross-linked PVOH (or other aqueous solution which also provide, for example, oil resistance to the surface of a paper-based product) and a water-resistance additive to improve the oil-resistance effectiveness of the coating in some embodiments. It should be appreciated that people skilled in the art may add other components to the inventive coating composition or use it in conjunction therewith. For example, oil resistance may be further improved by adding clay nanoparticles, CaCO₃, or other mineral particles. Pigments, anti-foaming agents, and the like may also be added. In embodiments, the water stability of the inventive PVOH coating may be improved by using additional crosslinkers, including multifunctional acid such as citric acid (see e.g., U.S. Pat. Nos. 2,691,604 and 3,532,534), multifunctional aldehydes such as glyoxal, formaldehyde, (see e.g., U.S. Pat. No. 4,537,634) or borax, etc.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurement. The following examples are intended only to further illustrate the invention and are not intended in any way to limit the scope of the invention as defined by the claims.

### EXAMPLE 1

This example illustrates preparation of paper samples for testing. Gradually increasing amounts of water-resistance additive (as explained below) were added into pulp slurries to create gradually increasing water resistance in obtained paper samples. As shown in more detail below, it was observed that the oil resistance effectiveness of the inventive polyvinyl alcohol (PVOH) coating on the paper samples was significantly enhanced and then saturated along with water resistance. The formulation used 15 g of bleached hard-wood pulp commercially sold in sheet form. The sheets were hand torn into pieces of approximately 2 cm² and put into a juice blender with 300 mL of distilled water. After about 15 min of soaking, the pulp pieces were hand mortared and stirred using a spatula into a mash until no presence of evident pulp chunks was observed. An additional 300 mL of distilled water was poured into the blender and the pulp mash was dispersed into a uniform stable suspension by hand stirring with a spatula. The mixture was machine blended at a low speed for 6 s. The pH of the slurry was adjusted to pH 8.0-8.5 by adding 0.5N NaOH.

After sitting for at least 30 min, the slurry was cast into an 8-inch sieve with 100 meshes per inch and an opening of 149 μm in a bath of tap water. The sieve was put onto an 8-inch diameter pan and the circumferential opening between the two was sealed with parafilm. Vacuum was applied through a hole drilled in the sidewall of the pan to extract most of the liquid out of the cast slurry. The vacuum-dried and shaped pulp sheet was removed from the sieve and transferred onto three overlapping layers of aluminum woven mesh with 16 meshes per inch and opening of 1.14 mm. A layer of Mylar sheet was then placed on top of the pulp sheet, and this sandwich construct was pressed under 5k lb at 185° C. for 45 s on a Carver presser. During hot pressing, hot vapor was quickly released mainly via the mesh layers at the bottom. The obtained paper samples had a smooth top surface and mesh-imprinted bottom surface. The coating and testing of this example were performed on the smooth top surface. The imprint mesh depth was approximately 0.15 mm and gross thickness was about 0.8-0.9 mm.

Varying amounts of hydrophobic water-resistance additive (WRA) were added into the pulp slurries. Solenis Hercon™ 295 at pH 2.1-3.5 with 22-24% solids having an effective component of alkyl ketene dimer was used (e.g., available from Brenntag Specialties, Inc., South Plainfield, N.J.) and added into the pulp slurry as WRA which was hand-stirred and then briefly blended. Tests of water and oil resistances were taken after the samples sat in ambient conditions for at least 24 hrs after final hot pressing.

### EXAMPLE 2

This example illustrates the inventive composition and method via spray coating and the conferred level of oil resistance. The PVOH coating solution and coated amount were the same for all tested paper samples. A solution of 14% PVOH was used in this example. Aquaseal™ X2281 is a high solids barrier coating based on a vinyl alcohol resin in water. Despite its high degree of hydrolysis, it has been possible to achieve a 20% solids content while maintaining the viscosity at 500 cPs allowing higher coating weights to be achieved with existing equipment. The barrier performance remains humidity sensitive above about 23° C./65% humidity, which never occurred in our experiments. The Aquaseal™ X2281 solution was diluted with distilled water to achieve a 14% PVOH solution.

The 8-inch samples prepared in Example 1 were cut evenly into four quarters and one gram of the 14% PVOH solution was sprayed onto one side of the quarter cut samples using an airbrush at 40 psi. Alternatively, airless pressurized sprayers may be used which allow much higher solution concentration and hence viscosity than airbrush sprayers. The sprayed coating was dried by blowing hot air onto the samples for 2 min using a heat gun of 120V 5A. The samples were about 5 cm away from mouth of the heat gun, where the measured temperature was about 80-100° C., and the samples sat flat on a suspended mesh to allow vapor to escape through the mesh.

Table 1 shows observational results for samples with a varying amount of WRA added and no PVOH coating. Results were observed after water or oil at room temperature was dropped onto the samples. Table 2 shows observational results for oil resistance where each sample received lg of the inventive PVOH coating. For the water test, distilled water was dripped over the samples. For the oil test, purified soybean oil droplets were placed all over the samples. When the oil was not quickly absorbed, oil drops immediately tend to spread out, so the oil was manually spread out to a continuous thin layer to prevent oil flow out of the coated area.

It was observed that with gradually increasing amounts of WRA added into the pulp slurries, oil resistance was significantly enhanced and saturated along with water resistance for both uncoated samples in table 1 and coated samples in table 2, but the enhancement for uncoated samples was nearly negligible in comparison to that of corresponding coated samples. The enhancement of oil resistance for coated samples should be associated with improved effectiveness of the coating since the same amount of coating solution was applied to all samples. Detailed results in Example 3 supported a mechanism of the improvement: with increasing WRA amount, the coating was able to form a more continuous coating, which may be associated with less penetration of coating solution into sample surface of gradually increasing water during spraying.

The WRA additive used here is a type alkyl ketene dimer (AKD). Results showed that the enhancement effectiveness was good enough when 0.6 g WRA was added, which amount is about ½ used commonly in real production. Efficiency of AKD conjugate to pulp fibers is far less than 100%, so the amount of AKD added into pulp slurry can be apparently higher than its FDA regulation of 0.4 wt % in final paper product.

On a highly hydrophobic surface such as that of Teflon™, the inventive aqueous coating will be unable to spread out on the surface. So there is an optimal range of hydrophobicity of the surface to be coated, which in this case definitely covers the conventional industrial range of paper products with WRA. Appropriate hydrophobicity of paper surface can also be approached by adding other WRA aqueous systems or by precoating a hydrophobic layer of wax, polyethylene, alkyl succinic anhydride, rosin, acrylate, styrene-butadiene copolymer, etc. Hydrophobic chemical groups may be also grafted onto paper surface by known methods such as radiation, vapor reaction, etc.

### EXAMPLE 3

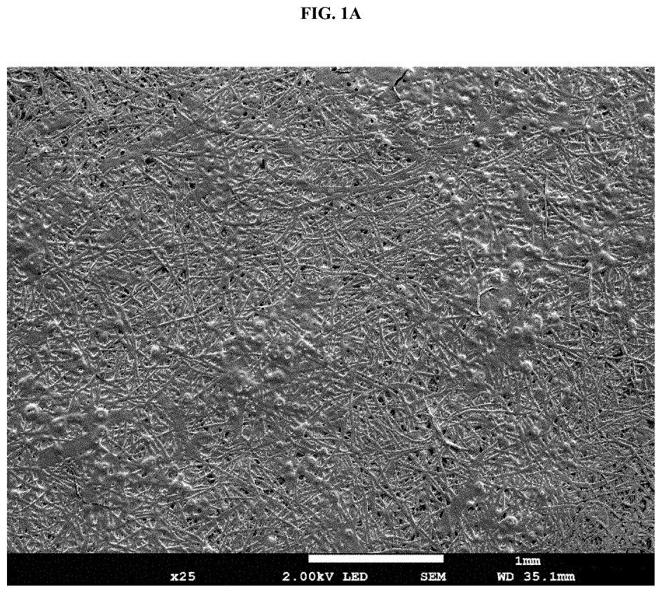

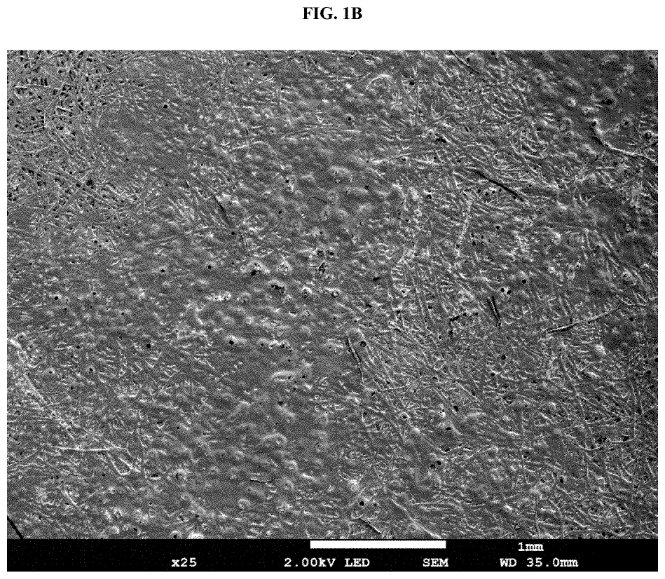

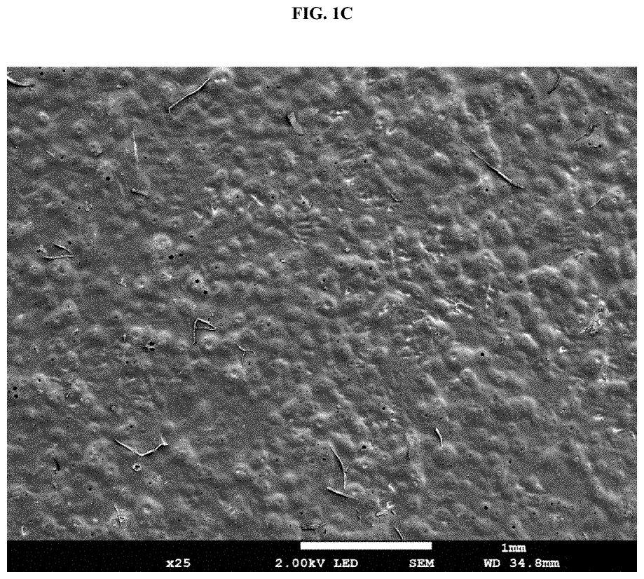

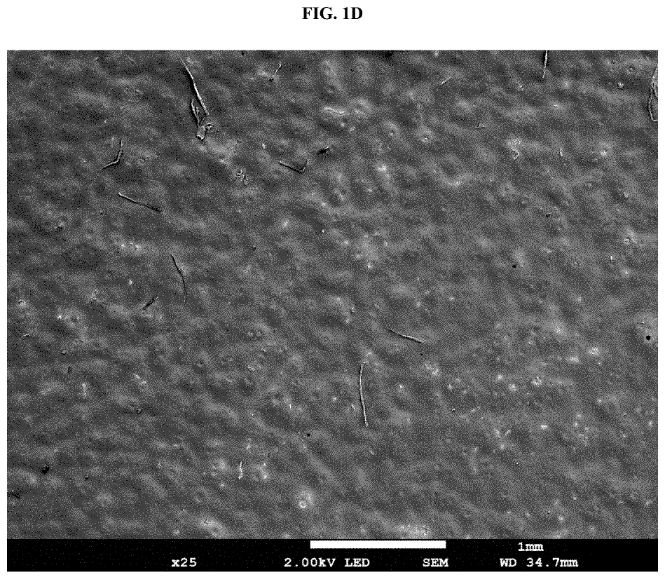

This section shows the surface texture change of final dried coated samples with different amounts of WRA added at the beginning of sample preparation by scanning electron microscope (SEM) images of the respective surfaces. The images are in agreement with the change of hydrophobicity of uncoated samples and with the change of oil resistance for coated samples. FIG. 1A shows an SEM image of a sample treated with sprayed PVOH solution in the absence of WRA. The PVOH was observed to mostly penetrate the surface, and after drying the surface was dominated by exposed porous fibrous structure. In FIG. 1B, it was observed that continuous coating blocks began to form with the application of the PVOH coating when 0.15 g WRA was added. For a treatment with 0.3 g WRA and PVOH spray coating as in FIG. 1C, it was observed that after drying the surface was dominated by a continuous coating as well as a significant number of pinholes. FIG. 1D shows an SEM image of a sample treated with 0.6 g WRA. It was observed that the surface was dominated by a continuous coating after drying, while the number of pinholes in the coating was reduced, and the surface became flatter in appearance. For oil resistance of paper-based products the fewer pinholes the better.

While this invention may be embodied in many different forms, there are described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety, including any materials cited within such referenced materials. In addition to the citations above, the contents of the following references are also incorporated herein by reference in their entirety: U.S. Pat. Nos. 7,588,831; 8,110,071; 8,273,435. Furthermore, the invention encompasses any possible combination of some or all of the various embodiments and characteristics described herein and/or incorporated herein. In addition, the invention encompasses any possible combination that also specifically excludes any one or some of the various embodiments and characteristics described herein and/or incorporated herein.

Thus, in view of the above, there is described (in part) the following:

A method of forming a continuous layer of an aqueous coating on the surface of a paper-based product, said method comprising (or consisting essentially or consisting of) applying an aqueous coating (e.g., solution of poly(vinyl alcohol)) to a surface of said paper-based product, wherein said surface is hydrophobic, wherein said aqueous coating provides a characteristic (or function) to said surface, and wherein said method does not use polyfluoroalkyl substances. The characteristic (or function) may be, for example, oil resistance, oxygen barrier, moisture barrier, electromagnetic shielding, surface conductivity of electricity or heat, surface color homogeneity, smoothness, etc.

The above method, wherein said aqueous coating is an aqueous solution of poly(vinyl alcohol). The above method, wherein said aqueous solution has a viscosity from about 10 cPs to about 2000 cPs, The above method, wherein said viscosity is from about 50 cPs to about 1,000 cPs. The above method, wherein said viscosity is from about 100 cPs to about 600 cPs.

The above method, wherein said poly(vinyl alcohol) has a hydrolysis extent from about 60% to about 99%. The above method, wherein said poly(vinyl alcohol) has a hydrolysis extent from about 70% to about 99%. The above method, wherein said poly(vinyl alcohol) has a hydrolysis extent from about 80% to about 99%.

The above method, wherein said aqueous solution of poly(vinyl alcohol) has a poly(vinyl alcohol) concentration in terms of wt/vol from about 2% to about 30%. The above method, wherein said aqueous solution of poly(vinyl alcohol) has a poly(vinyl alcohol) concentration in terms of wt/vol from about 5% to about 20%. The above method, wherein said aqueous solution of poly(vinyl alcohol) has a poly(vinyl alcohol) concentration in terms of wt/vol from about 8% to about 16%.

The above method, wherein said poly(vinyl alcohol) has a molecular weight of from about 5,000 g/mol to about 500,000 g/mol. The above method, wherein said poly(vinyl alcohol) has a molecular weight of from about 10,000 g/mol to about 200,000 g/mol. The above method, wherein said poly(vinyl alcohol) has a molecular weight of from about 20,000 g/mol to about 50,000 g/mol.

The above method, wherein the paper-based product comprises a water-resistance additive.

The above method, wherein said paper-based product is a food container.

The above, wherein said characteristic or function is oil resistance.

An article of manufacture produced using the above method.

The above article of manufacture wherein said paper-based product is a food container.

The invention illustratively disclosed herein suitably may be practiced in the absence of any element (e.g., method (or process) steps or composition components) which is not specifically disclosed herein. Thus, the specification includes disclosure by silence (“Negative Limitations In Patent Claims,” AIPLA Quarterly Journal, Tom Brody, 41(1): 46-47 (2013): “. . . Written support for a negative limitation may also be argued through the absence of the excluded element in the specification, known as disclosure by silence . . . Silence in the specification may be used to establish written description support for a negative limitation. As an example, in Ex parte Lin [No. 2009-0486, at 2, 6 (B.P.A.I. May 7, 2009)] the negative limitation was added by amendment . . . In other words, the inventor argued an example that passively complied with the requirements of the negative limitation . . . was sufficient to provide support . . . This case shows that written description support for a negative limitation can be found by one or more disclosures of an embodiment that obeys what is required by the negative limitation . . . .”

Other embodiments of the invention will be apparent to those skilled in the art from a consideration of this specification or practice of the invention disclosed herein. It is intended that the specification and examples be considered as exemplary only, with the true scope and spirit of the invention being indicatedy the following claims. Although any methods and materials similar or equivalent to those described herein can be used in the practice or testing of the present invention, the preferred methods and materials are herein described. Those skilled in the art may recognize other equivalents to the specific embodiments described herein which equivalents are intended to be encompassed by the claims attached hereto.

TABLE 1

| WRA | Water | Oil |
|---|---|---|
| None | Water drops instantly absorbed | Evident stains instantly |
| | fully | form. Oil drops |
| | | are fully absorbed |
| | | in about 50 s to 2.5 min. |
| 0.15 g | Stains instantly formed. Water | Comparable to above |
| | drops fully absorbed in about 5 s. | |
| 0.3 g | No evident stain forms. Water drops | Comparable to above |
| | starts being gradually absorbed | |
| | at about 9 min, and about | |
| | 20% number of drops are fully | |
| | absorbed in about 1.5 hr. | |
| | The other about 80% drops | |
| | remain until fully evaporation. | |
| 0.6 g | All water droplets remained on | Evident oil stains instantly |
| | surface until fully evaporated | formed. Oil droplets were |
| | | fully absorbed into the |
| | | material about 1.5 min to |
| | | 8 min. |
| 0.9 g | All water droplets remained on | Comparable to above |
| | surface until fully evaporated | |
| 1.2 g | All water droplets remained on | Comparable to above |
| | surface until fully evaporated | |
| 1.8 g | All water droplets remained on | Comparable to above |
| | surface until fully evaporated | |

TABLE 2

| WRA | Oil |
|---|---|
| None | Evident stains instantly form. Oil drops are |
| | fully absorbed in about 50 s to 2.5 min. |
| 0.15 g | Evident stains formed on surface about 20% of test |
| | area instantly, 40% at 1 hr, 60% at 6 hr, and 100% at 72 hr. |
| 0.3 g | Faint stain dots of about 1 mm diameter formed at about |
| | 15 min. Faint stain dots of about 1-5 mm diameter |
| | together take about 3% of test area at 24 hr, |
| | and 5% at 96 hr. |
| 0.6 g | Oil remains on surface and solidifies in air in ~3 weeks |
| | due to oxidation. |
| 0.9 g | Oil remains on surface and solidifies in air in ~3 weeks |
| | due to oxidation. |
| 1.2 g | Oil remains on surface and solidifies in air in ~3 weeks |
| | due to oxidation. |
| 1.8 g | Oil remains on surface and solidifies in air in ~3 weeks |
| | due to oxidation. |

The claimed invention is:

1. A method of forming a continuous layer of an aqueous coating on the surface of a paper-based product, said method comprising applying an aqueous coating to a surface of said paper-based product, wherein said surface is hydrophobic, wherein said aqueous coating provides a characteristic to said surface, and wherein said method does not use polyfluoroalkyl substances.

2. The method of claim 1, wherein said aqueous coating is an aqueous solution of poly(vinyl alcohol).

3. The method of claim 2, wherein said aqueous solution has a viscosity from about 10 cPs to about 2000 cPs,

4. The method of claim 2, wherein said viscosity is from about 50 cPs to about 1,000 cPs.

5. The method of claim 2, wherein said viscosity is from about 100 cPs to about 600 cPs.

6. The method of claim 2, wherein said poly(vinyl alcohol) has a hydrolysis extent from about 60% to about 99%.

7. The method of claim 2, wherein said poly(vinyl alcohol) has a hydrolysis extent from about 70% to about 99%.

8. The method of claim 2, wherein said poly(vinyl alcohol) has a hydrolysis extent from about 80% to about 99%.

9. The method of claim 2, wherein said aqueous solution of poly(vinyl alcohol) has a poly(vinyl alcohol) concentration in terms of wt/vol from about 2% to about 30%.

10. The method of claim 2, wherein said aqueous solution of poly(vinyl alcohol) has a poly(vinyl alcohol) concentration in terms of wt/vol from about 5% to about 20%.

11. The method of claim 2, wherein said aqueous solution of poly(vinyl alcohol) has a poly(vinyl alcohol) concentration in terms of wt/vol from about 8% to about 16%.

12. The method of claim 2, wherein said poly(vinyl alcohol) has a molecular weight of from about 5,000 g/mol to about 500,000 g/mol.

13. The method of claim 2, wherein said poly(vinyl alcohol) has a molecular weight of from about 10,000 g/mol to about 200,000 g/mol.

14. The method of claim 2, wherein said poly(vinyl alcohol) has a molecular weight of from about 20,000 g/mol to about 50,000 g/mol.

15. The method of claim 2, wherein the paper-based product comprises a water-resistance additive.

16. The method of claim 2, wherein said paper-based product is a food container.

17. The method of claim 1, wherein said characteristic is oil resistance.

18. An article of manufacture produced using the method of claim 1.

19. The article of manufacture of claim 18 wherein said paper-based product is a food container.
